(19) United States
(12) Patent Application Publication
(10) Pub. No.: US 2019/0003248 A1
(43) Pub. Date: Jan. 3, 2019

(54) HIGH-PRESSURE RESISTANT FABRIC FIRE SHUTTER

(71) Applicant: U.S Smoke & Fire Corporation, Reston, VA (US)

(72) Inventor: Douglas J. Bailey, Grand Island, NY (US)

(73) Assignee: U.S Smoke & Fire Corporation, Reston, VA (US)

(21) Appl. No.: 15/990,244

(22) Filed: May 25, 2018

Related U.S. Application Data
(60) Provisional application No. 62/525,921, filed on Jun. 28, 2017.

(51) Int. Cl. E06B 5/16; E06B 9/13; E06B 9/58; A62C 2/06

(52) U.S. Cl. CPC E06B 5/16; A62C 2/06; E06B 9/58; E06B 9/13

(57) ABSTRACT

A fire shutter for preventing the spread of fire and smoke through an opening such as a door in a building structure that is resistant to pressure from a high-pressure hose. A flexible coated fabric composite, using high-temperature and high-pressure resistant materials. The shutter combines two layers of texturized fiberglass fabric, wherein each layer combines fiberglass and wire strands, with one strand wrapped in a spiral around the other, in both the warp and weft directions. The fabric is impregnated with vermiculite. Each layer of fabric, containing the fiberglass and wire strands, is coated, on an outer portion, with a high temperature stabilized, functionally filled polymer. After exposure to an extreme temperature condition, immediately followed by a standard hose test, the fire shutter functions as a fire partition, without smoke, fire or water penetration, while remaining flexible and allowing for egress.

This application claims benefit of Provisional Application Ser. No. 62/525,921 filed on Jun. 28, 2017.

### FIELD

The present disclosure is generally directed to a fabric fire shutter, or hose stream-tested shutter, and method of manufacture, with low flammability, non-fire penetration, non-permeability to smoke and resistant to high pressure, such as pressure created by contact with water from a fire hose.

### BACKGROUND

Fire shutters, or curtains, are a common means of preventing the spread of a fire throughout a building, while also allowing a potential victim to escape the fire. Fire curtains are an effective alternative to steel doors. Steel door are useful as a fire stop device; however, they can, in certain circumstances, prevent escape from a fire.

Fire curtains have attempted to limit the spread of fire and smoke by sealing openings with a flexible protection member manufactured from a fire resistant material that can be wound around a reel or winding shaft. The fire resistant materials used in such devices typically include woven textile fabrics having warp and weft threads. The flexible protection members are generally stretched by a plurality of wires that extend between rollers moving in guides mounted relative to an opening in a building wall. Beneficially, these devices reduce the spread of fire and smoke, are relatively light in weight, and save space. However, these devices are generally less resistant to mechanical influences and loads than devices of the first type, such as a steel door, described above. Additionally, after exposure to the heat of a fire, the flexible protection members tend to become brittle and tear when struck with a stream of extinguishing water during a fire. Consequentially, many of these devices cannot pass the Hose Stream Test. Fire curtains effectively provide a means of escape; however, they often tear when subjected to pressurized water from a fire hose. In many jurisdictions, fire codes often require a fire door to be able to withstand the force of a fire hose, thereby limiting the use of fire curtains as an alternative to steel doors.

Passive fire protection means are designed to isolate and contain fires in buildings, with the key goal of limiting the spread of fire and therefore limiting the property damage. Asset protection and property damage mitigation are important goals of passive fire protection; however, fixed systems require a fully closed position, which may prevent potential victims of the fire from escaping.

Deployable metal doors and shutters do have an advantage over the fixed systems, as they can activate as required by a fire, thus insuring they are closed, but then provide the same trap for potential victims of the fire as the fixed steel doors.

Deployable fire curtains provide the same benefits as do fixed fire protection, including fire and smoke containment, but with active sensing to deploy automatically, allow egress, even in a total power loss situation.

Steel doors and shutters offer one significant advantage over traditional smoke and fire curtains used in civil construction, which is the ability to withstand the water pressure of a fire fighters hose stream without penetration. This requirement is mandated in many fire stop applications, and enforced by local code officials.

Various means of enhancing the heat resistance of fabric materials are known in the art. The impregnation texturize fiberglass fabrics with vermiculite particles has been demonstrated to increase the fabrics temperature stability from 1000° F. to 2000° F.

Similar coatings to Newtex's Z-Block coating are currently manufactured by several companies, and when applied to fine non-texturized filament fabrics, including those containing wire reinforcement, are currently used in fire curtain systems.

Internal testing done by Newtex and publicly shared, shows that coating one side of a vermiculite impregnated fabric with a high temperature stabilized polymer coating such as on theater fire curtains, can enhance the thermal insulation properties, but two-sided coating of the same fabric with the same coating can be detrimental.

Other system that claim to meet the fire endurance/hose stream test as outlined by UL10B, have relied on using at least three layers of material, with one of those layers being a conductive barrier such as a thin stainless steel sheet. Three layer systems, lacking intimate bonding, have inherent issues with rolling and unrolling around a common mandrel.

### SUMMARY

The present disclosure relates to a coated fabric composite, using high-temperature and high-pressure resistant materials in a novel configuration. Broadly described, the present invention comprises a fire and smoke protection system, including apparatuses and methods, for limiting the spread of fire and smoke through an opening. In embodiments of the present disclosure described herein, the fire and smoke protection system comprise components that may be included, constructed and configured to meet the requirements of particular applications and of the Hose Stream Test. As described herein with respect to example embodiments, the fire shutter may be configured in a variety of arrangements using a variety of materials, alone or in combination, and using a variety of construction methods. Generally and without limitation, the fire shutter of the present disclosure may be manufactured using fire resistant woven fabric elements, and wire elements in various arrangements, with each material, element and arrangement having the capability to resist external forces and retain mechanical strength and stability sufficient to pass the Hose Stream Test.

The fabric fire shutter of the present disclosure combines two layers of texturized fiberglass fabric, wherein each layer combines fiberglass and wire strands in a wrap, with one strand wrapped in a spiral around the other, in both the warp and weft directions. The fiberglass fabric is impregnated with vermiculite. In a preferred embodiment, vermiculite is applied first, followed by polyurethane, pigmented, aluminum flake coating. In one embodiment, following application of vermiculite, each layer of fabric, containing the fiberglass and wire strands, is coated, on an outer portion, with a high temperature stabilized, functionally filled polymer.

The fabric fire shutter of the present disclosure can resist the pressure of a conventional fire hose without breakage. After exposure to an extreme temperature condition, such as that of a 2 hour ASTM E-119 fire endurance test, immediately followed by the standard hose test per ASTM E-2226, the fabric fire shutter of the present disclosure will still fully function as a fire partition, without smoke, fire or water penetration. The fabric fire shutter of the present disclosure will remain flexible and allow egress like other fire shutter or curtain systems, and can be deployed or retracted in a manner typical to these systems.

The high-performance fabric fire shutter of the present disclosure provides additional advantages over other deployable fire curtains, including cut and tear resistance for security, and thermal insulation for lower cold side temperature for providing safe passage.

### BRIEF DESCRIPTION OF THE DRAWINGS

FIG. 1 is a flow diagram of the method of the present disclosure.

FIG. 2 shows a top view of a wire wrapped yarn of the present disclosure.

FIG. 3 shows a front view of the weave of fabric fire shutter of the present disclosure.

FIG. 4 shows a cross sectional view of a composite lay-up of the present disclosure.

FIG. 5A shows a cross sectional side view of the fire shutter of the present disclosure.

FIG. 5B shows a magnified view of the overlap at the seams having a double stitch of the fire shutter of the present disclosure.

FIG. 5C shows a side view of the fire shutter of the present disclosure.

FIG. 5D shows a cross sectional view of the fabric sheet and side guide of the present disclosure.

FIG. 6 is a flow chart of an embodiment of the present disclosure.

### DETAILED DESCRIPTION

The present disclosure relates to a fabric fire shutter comprised of two layers of texturized fiberglass fabric that are fastened together to provide a novel heat and pressure resistant fabric.

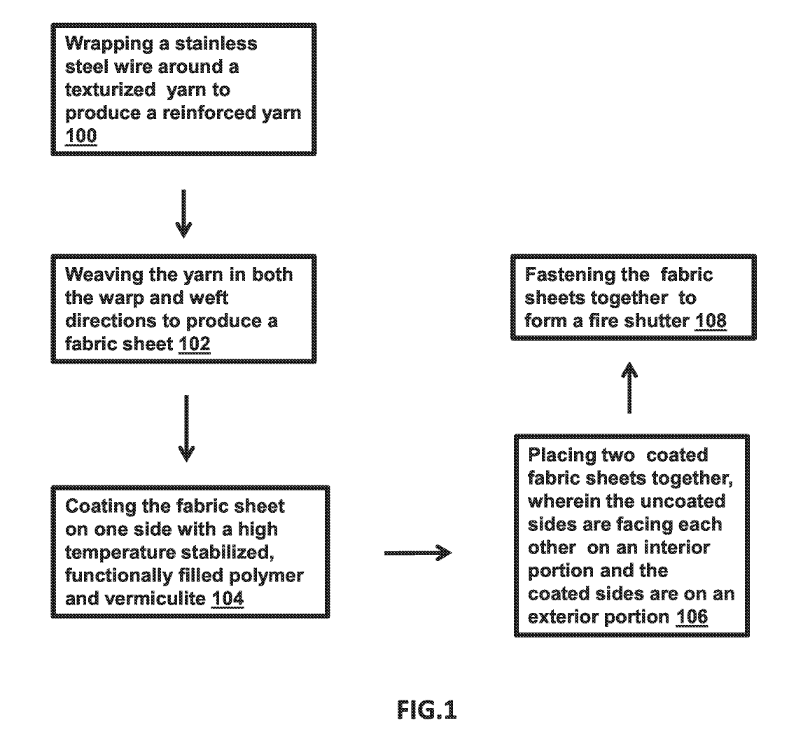

With regard to FIG. 1, the flow chart describes steps in an embodiment of the present disclosure which include wrapping 100 a texturized fiberglass yarn with wire to form a reinforced texturized yarn 150. The reinforced texturized yarn is then woven 102 in both the warp and weft directions to form a fabric sheet. The resulting fabric sheet is then coated 104 on one side with a high temperature stabilized functionally filled polymer containing vermiculite to form a coated sheet. Two coated sheets are then placed together 106, wherein the uncoated sides are on the interior and the coated sides on the exterior, and fastened together 108 to form a fire shutter.

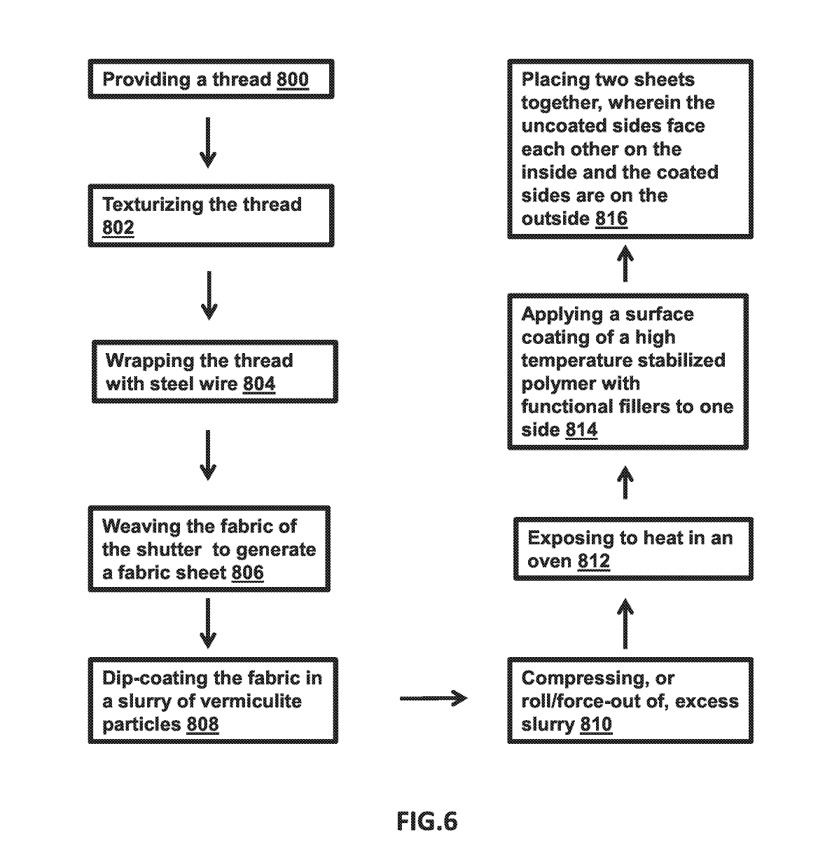

Another flow chart disclosing an embodiment of the present disclosure is shown in FIG. 6. These steps include providing 800 a thread. Texturizing 802 the thread. Wrapping 804 the thread with steel wire. Weaving 806 the fabric of the shutter to generate a fabric sheet. Dip-coating 808 the fabric in a slurry of vermiculite particles. Compressing 810, or roll/force-out of, excess slurry. Exposing 812 to heat in an oven. Applying 814 a surface coating of a high temperature stabilized polymer with functional fillers to one side. Placing 816 two sheets together, wherein the uncoated sides are on the inside and the coated sides are on the outside.

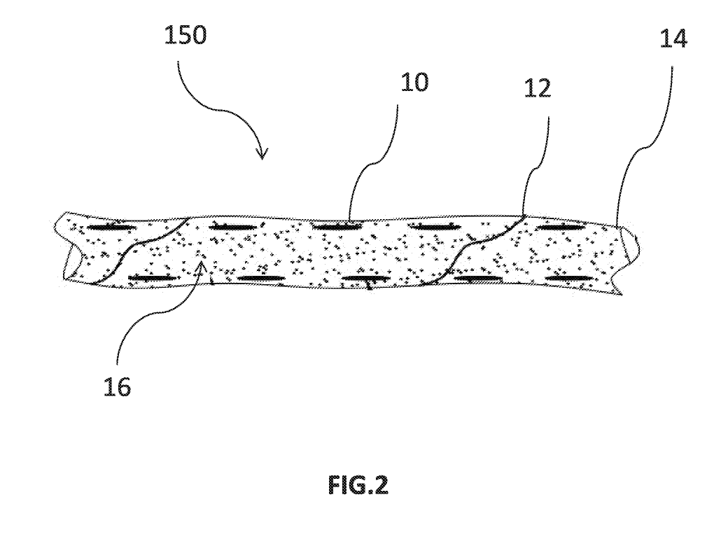

With regard to FIG. 2, in one embodiment, a stainless steel wire 12 is wound around a texturized yarn 14 comprised of fiberglass. Texturized yarn 14 may be comprised of a bundle of voluminized high temperature (e-grade fg) continuous 6-y filament. Texturized yarn 14 is texturized to provide a gripping surface for steel wire 12 and cavities in which vermiculite particles 10 can settle. The texturization of the continuous filament glass yarns 14 (wherein yarn may alternatively be referred to as a fiber or thread) is critical to anchor steel wire 12 in place on texturized yarn 14. Use of a continuous filament fiber for texturized yarn 14 is an important feature for present disclosure. Additionally, the continuous filament fiber that comprises texturized yarn 14 may be a high temperature fiber. High temperature fibers may be comprised, preferably, of e-glass grade fiber, which is a silica fiber. S-glass may alternatively be used as a high temperature fiber. Alternatively, high temperature fibers may be comprised of quartz or may be ceramic. Aluminum borosilicate may comprise a high temperature fiber, and may include fibers produced by Nextel™

Texture may, in some embodiments, be native to texturized yarn 14, meaning that texturized yarn 14 may be rough to the touch. The texture grips steel wire 12 by allowing steel wire 12 to slip between gaps in the surface of texturized yarn.

With regard to texturization of the continuous fiberglass yarn, there are two processes that may be used to produce a texturized yarn 14 for the present disclosure. In a preferred embodiment, both of these processes may be used. The first process used in texturization is known as the lex process, which is known to one of ordinary skill in the art. The second process is known as a volumization process, as would be known to one of ordinary skill in the art. Finer filaments and coarser filaments are known in the art. For example, if a ⅛ inch diameter fiberglass yarn is selected, the yarn may contain 200 filaments when 6 micron filaments are used. Depending on the width of the filaments, the present disclosure may require more filaments to consume the necessary amount of space. For example, if a 1 micron filament is used, 1200 individual filaments would be necessary to consume the same amount of space that a yarn comprised of 200, 6 micron filaments would consume.

Each fiberglass filament used in the present disclosure is comprised of hundreds of smaller filaments, wherein 6 micron filaments are preferred in the present disclosure.

With regard to the volumization process, the process starts off with fiberglass filament yarns, which may be a 1/32 inch yarn with hundreds of filaments. For example, a 10 inch bundled yarn may be selected and pulled through a machine, then injected with high pressure air, as would be known to one of ordinary skill in the art. After being subjected to this volumization process, the original 1/32 inch yarn becomes a ¼ inch yarn.

With regard to the lex process, as would be known to one of ordinary skill in the art, a yarn is put into a machine faster than it is removed from the machine, resulting in a compression of the yarn that forms bumps on the fibers. Fiber entanglement 16 (shown in FIG. 1) occurs through the lex overfeed process. For the purposes of the present disclosure, both the volumization process and the lex process may be used to create a fiberglass texturized yarn 14 for further treatment according to the process of the present disclosure. Both the volumization and lex processes may be applied simultaneously to achieve the desired result. Using both the volumization and lex processes on the silica yarn creates bumps and voids. The bumps hold steel wire 12 in place. The voids provide a location for vermiculite particles 10 accumulate.

Steps in the process of the present disclosure include providing a fiber yarn; texturizing the yarn; wrapping texturized yarn 14 with steel wire 12; and weaving a fabric sheet of the shutter, which may preferably be performed on a loom.

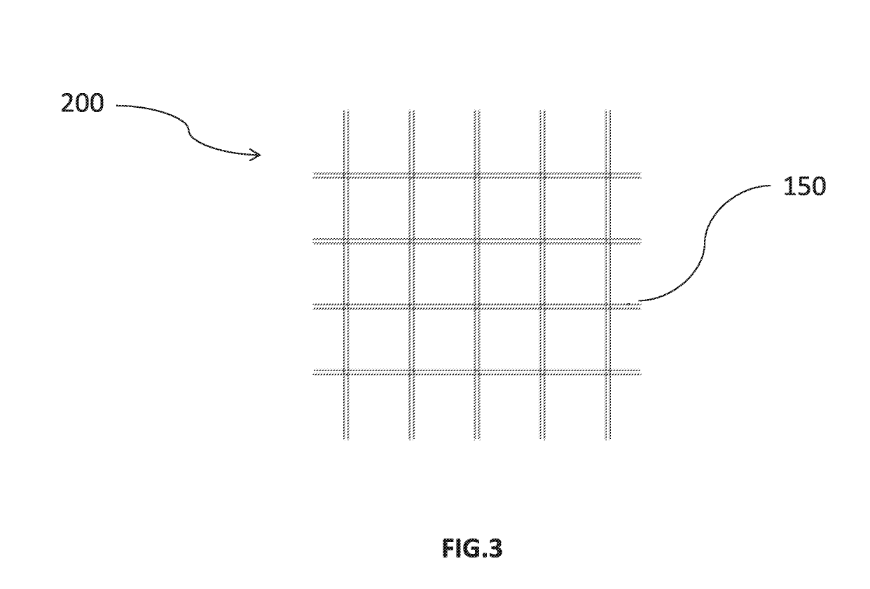

The wrapping of texturized yarn 14 with steel wire 12 may preferably be performed by a machine designed for this purpose, as would be known to one of ordinary skill in the art. Steel wire 12 may be ultra-thin stainless steel wire. Preferably, steel wire 12 may have a diameter of 0.005 inches, although a range of between 0.004 to 0.008 inches may also be effective. Steel wire 12 must be high temperature wire (meaning that the wire will not breakdown or melt at a fire temperature, such as a temperature reached during an ASTM E-119 test). In a preferred embodiment, steel wire 12 reinforces texturized yarn 14. Steel wire 12 is preferably wound tightly around texturized yarn 14, forming a tight helix. In a preferred embodiment, two steel wires 12 are spirally wound around a continuous fiberglass texturized yarn 14 to form a composite reinforced texturized yarn 16 comprised of steel and fiberglass. The steel wire 12 wrap is continuous and may be performed by machine to encircle the fiberglass yarn through a feeder device. The use of two steel wires 12 wrapped around a single fiberglass texturized yarn 14 may provide greater flexibility than the use of a single steel wire 12, although alternatively a single steel wire 12 may also be effective. Differential of elongation, wherein steel wire 12 will stretch but texturized yarn 14 does not. Alternatively, in some embodiments, texturized yarn 14 may be wound around steel wire 12 to form a steel core yarn. The range of width of texturized yarn 14 is preferably less then 4 mm. In this embodiment, steel wire 12 is wrapped around reinforced texturized yarn 16 in both the warp and weft directions when the shutter fabric sheet 200 (shown in FIG. 3) is produced. Production of a wire mesh matrix within fabric sheet 200 is important to the present disclosure.

Once a combined steel wire 12 and texturized yarn 14 is formed a fabric sheet is created by weaving the combined steel wire 12 and texturized yarn 14 together in both the warp and weft directions. Production of a wire mesh matrix inside the fabric sheet is important to the present disclosure. In one embodiment, each strain of texturized yarn 14 in both the warp and weft directions of the fabric sheet 200 is reinforced by spiral winding two ultra-fine stainless steel wires 12.

With regard to FIG. 3, a fabric sheet 200 formed from reinforced texturized yarn 150 is shown. The weave of fabric sheet 200 may preferably be a plain weave, as shown in FIG. 3, which results from over/under repeats performed during the weave. Further, a balanced weave for fabric sheet 200 is preferably disclosed, which is defined by an identical weave in both the warp and weft directions.

In the preferred embodiment, ten yarns per inch in both directions may define the count. The fabric sheet product may be provided, in one embodiment, by Newtex, where it may be referred to as a Z-tex 88/20. Z-tex 88/20 is a 6 micron yarn. After being woven together into a tightly packed cloth, the combined fiberglass and steel yarns are impregnated with vermiculite particles 10.

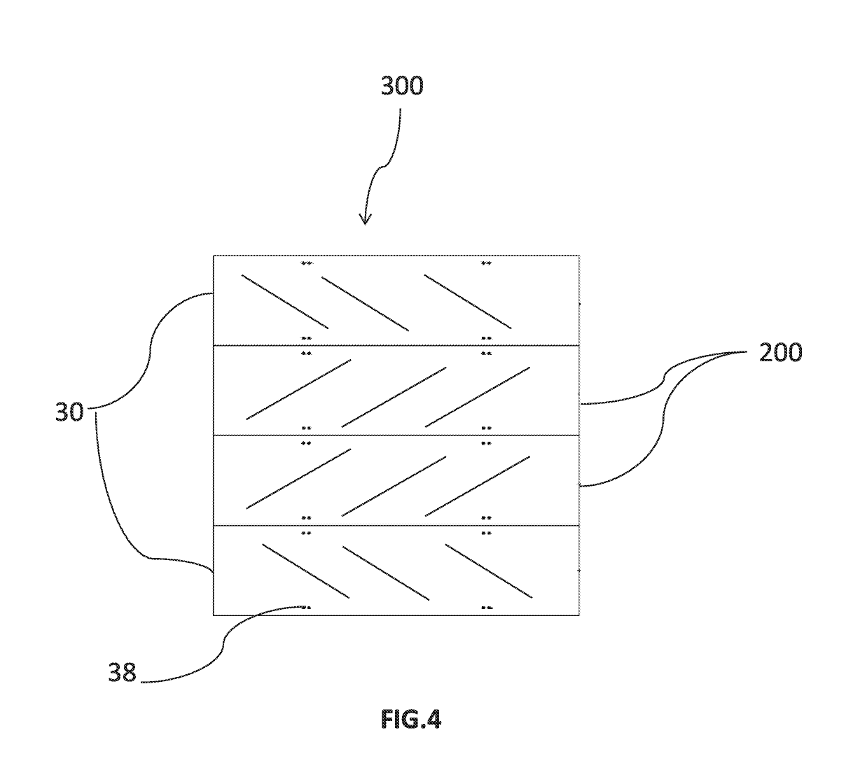

In one embodiment, a next step in the process of the present disclosure is to dip-coat fabric sheet 200 in slurry of vermiculite particles 10. This step includes a surface coating 30 (shown in FIG. 4) to fabric sheet 200, which, in some embodiments includes an application of a Z-block coating to one side. As shown in FIG. 1, vermiculite particles 10 accumulate in voids in texturized yarn 14.

The texturization is important for holding the vermiculite particles 10 in the fabric in the proper orientation. The vermiculite particles 10 may be contained as a solute in a solvent such as the brominated polyurethane Z-block coating manufactured by Newtex. Z-block coating is known in the art; however, different variations of the coating exist from manufacturer to manufacturer. Z-block coating may, in some embodiments, contain a brominated polyurethane aluminum trihydrate. Z-block coating may, in some embodiments, include a fire retardant composition and a smoke suppressant composition. A more general term for Z-block coating with regard to the present disclosure, as would be known in the art, is a high temperature stabilized polymer with functional fillers. In some embodiments, this coating is comprised of polyurethane, aluminum flake and pigments. Silicone or polyurethane may be included in some embodiments of Z-block coating. In some embodiments, vermiculite particles 10 may be applied to fabric sheet 100 prior to application of a high temperature polymer coating with functional fillers (silicon or polyurethane and aluminum flake).

In other embodiments, vermiculite particles 10 may be combined with a high temperature polymer coating with functional fillers (silicon or polyurethane and aluminum flake) and applied together as a solution. Valmiera Polyurethane 4415-2-SP may be used in some embodiments. Vermiculite is a solute in the solvent that acts as a stiffening agent in a final emulsion. The coating impregnates the final fabric sheet 200, thereby creating a uniform coating that protects fabric sheet 200 in a fire or fire test. In some embodiments, the coating may be hand-applied with a paint roller. In the preferred embodiment, each layer of the two layers of fabric sheet 200 is coated with a high temperature stabilized, functionally filled polymer such as the brominated polyurethane Z-block coating manufactured by Newtex on one side. Fabric sheet 200 may be dipped or hand coated.

It should be understood and appreciated that in other example embodiments, the fire shutter 400 may comprise additional woven fabric elements, intumescent elements, and/or layers of woven fabric, or other materials in the same or different sizes, shapes and arrangements.

A next step in the process of the present disclosure may, in some embodiments, include a compression roll to force out excess slurry (shown in FIG. 6), followed by exposure to an oven at approximately, in one embodiment, 600 degrees Celsius for form a coated fabric sheet.

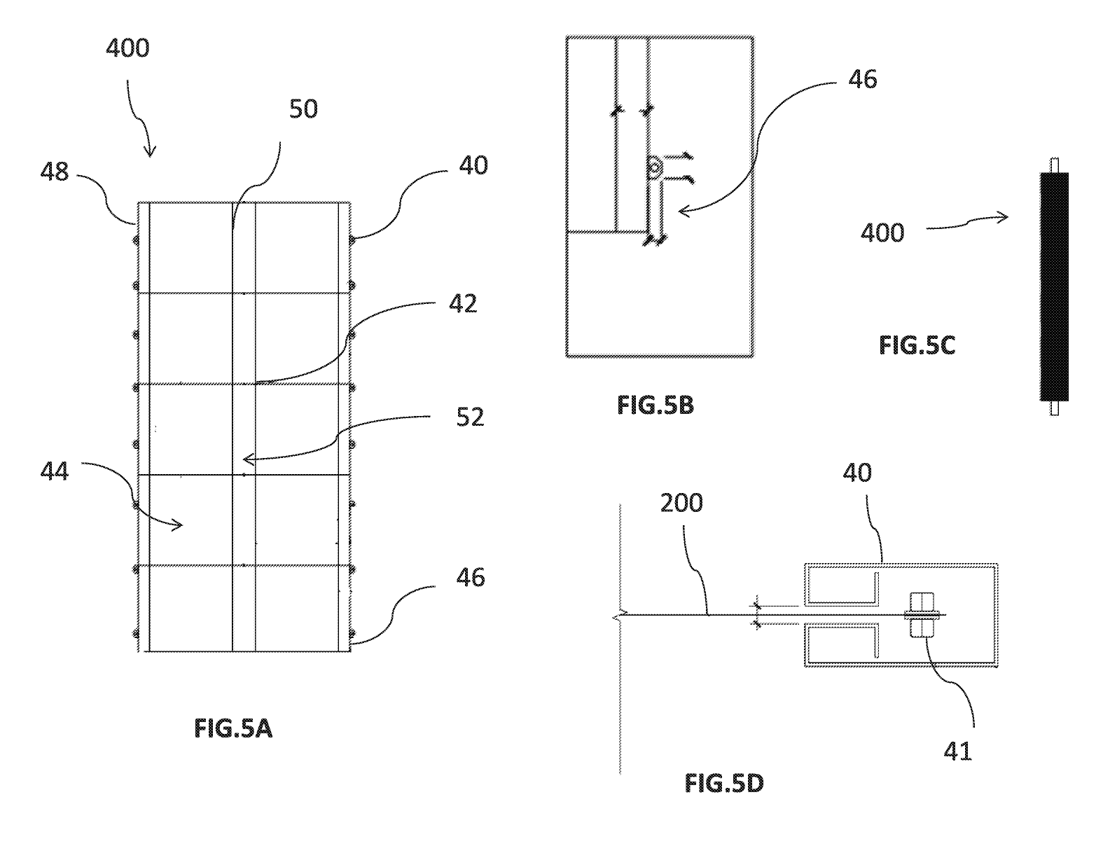

The two layers of fabric sheet 200, which are defined herein as vermiculite impregnated, wire reinforced, one sided coated fabrics, are then layered together such that the coating 30 (shown in FIG. 4) is apparent on the coated side 48 (shown in FIG. 5) on the external or exposed sides, and the uncoated sides 50 are in contact on the inner surfaces of each layer of fabric sheet 200 of shutter 400.

As shown in FIG. 4, following application of the coating to the exterior sides of two fabric sheets 200, the sheets are sewn together into a shutter 400. High temperature threads 38, which may in some embodiments be Kevlar™-type or stainless steel reinforced sewing thread, are used to quilt two fabric sheets 200 together.

As shown in FIG. 5A, in a preferred embodiment, fabric sheets 200 are sewn together in both directions to form a shutter 400. The polymer coated side 48 is on the exterior. Uncoated sides 50 are facing each other on the inside of the shutter 400. In one embodiment, interface 52, which may also be defined as an air gap, may separate the two layers of fabric sheet 200. Side guides 40, as shown in detail in FIG. 5D, which are in a preferred embodiment heavy duty guide tabs 41, which may also be referred to as curtain fabric retaining tabs, and guide pins are used to hold the sheets together. For the purposes of the present disclosure, heavy duty shall be defined as being designed to withstand a higher testing criteria in reference to fire endurance, wind load, hose stream test, temperature rise and insulation, as could be determined by one of ordinary skill in the art. Guide pins alone may not sufficiently hold the fire shutter together, therefore the present disclosure uses rugged guide pin and close spacing of the rugged guide pins. Guide pins may preferably be spaced between 6 to 9 inches apart. Rugged side (guide) pins are an important feature of the present disclosure, wherein rugged is defined for the purposes of any feature described as rugged in the present disclosure as a property of a component of the assembly that allows the component to withstand a higher testing criteria in reference to fire endurance, wind load, hose stream test, temperature rise and insulation, as could be determined by one of ordinary skill in the art. Close spacing of the metal tabs is an important feature of the present disclosure, wherein the metal tabs that hold the fabric in the assembly are closely spaced. The two layers of fabric sheet 200 are, in one embodiment, sewn together in a quilt pattern 42 on 24 inch centers, with stitch lines in both horizontal and vertical directions, using a double roll of stainless steel wire yarn. This construction allows the double layer fabric to roll as a single construction. The purpose of quilting is to take a multi-layer combination of sheets and quilt them together such that they may act as a single layer sheet. For the present invention, the sheets a preferably quilted in two directions, both length and width, such that the sheets may act as a single layer that contains, in a preferred embodiment, an interface 52. In a preferred embodiment, a square pattern of quilting is used. The fabric of the present disclosure is defined as heavy duty, specifically, a fabric component of the assembly that is designed with more metal wire and nominal weight to withstand higher testing standards than standard single layer systems to include a larger overlap of fabric to strengthen the fabric in order to withstand the fire hose.

It should be understood and appreciated, however, that seams 128A, 128B may alternatively use one or more rows of stitches, one or more stitching patterns, and one or more stitching arrangements as described or not described in the other example embodiments

With further regard to FIG. 5A, rugged guide pins are included and the spacing is close. The smoke curtain polymer coating may be Z-block 407. The fire curtain material may be comprised of zetexplus and A-820 Z-block 1S. The side guide retaining tab 41, as shown in FIG. 5D, may be comprised of zetexplus. Further components of the present disclosure may include flat seams, SS yarns, and a double line. There may, in some embodiments, be no labeling. Side guide retaining tabs 41 and pins may be added where necessary near the bottom of the shutter. FIG. 5B shows a magnified view of the overlap at the seams having a double stitch of the fire shutter of the present disclosure. FIG. 5C shows a side, or plan, view of the fire shutter of the present disclosure.

For the fabric sheet 200 of the present disclosure, maintaining strength under thermal stress is important. Strength of the fabric sheet 200 is determined by the diameter of the texturized yarn 14 and the filament size. Prior to exposure to high temperature fire conditions, such as the ASTM-119 test, in a preferred embodiment, 600 lbs may be the break strength for the fabric sheet 200. After exposure to a high temperature fire, the break strength may be reduced to, for example, approximately 300 lbs. For the present disclosure, in a preferred embodiment, the break strength is therefore reduced by approximately 50 percent after exposure to a high temperature fire. The minimum strength required for the present disclosure must be enough for the fire shutter to hold its own weight. For the present disclosure, in a preferred embodiment, the retained strength of the shutter material may be 500 lbs. The burst strength must be at least 95 psi to pass the hose test; or the E119 fire test. However, additionally passing the UL10B, the combined test, is relevant to the present disclosure.

The two layers of fabric sheet 200 are, in one embodiment, intimately joined through a cross stitching quilting pattern 42 using a double stitch line with stainless steel yarn. In one potential embodiment, a high temperature FR silicone adhesive can be used to pre-laminate the two layers together prior to quilting. Intimate bonding is a key factor in in the functionality of the fabric fire shutter 400, as it allows the two-layer system to functionally roll and retract as a single layer system.

The two-layer design may utilize an off-set ship-lap flat, butt seam, which is highly desirable. This type of seam not only allows for the fabrication of wide width shutters, but eliminates the need for the thickness build-up of traditional seam designs which include double fell (French) or simple overlaps. Thickness build up from the vertical seams are a roll-up problem and horizontal seams are never desirable as they are much weaker construction.

In a preferred embodiment, and as tested shown in Tables 1 and 2, enhanced guide pins may be used to anchor the shutter into the side guides to assist in the securing process for both the fire endurance and the hose stream exposures. The preferred embodiment may have a single roller system with enhanced side guide pins. Enhanced guide pins may be defined as guide pins having a greater length than a conventional bolt, as would be known in the art. A roller system is defined as a metal tube or series of tubes that house the fabric. In one embodiment an accordion design may be utilized, both vertically and horizontally.

This lay-up configuration, which in one embodiment has an interface 52 between layers, provides high levels of thermal transfer resistance in a very thin cross section, resulting in extremely low thermal conductivity, thereby providing the low temperatures measured on the unexposed surface during the fire endurance test described in Example 1 and shown in Table 2.

The fabric fire shutter manufactured according to the method of the present disclosure allows the two-layer system to functionally roll and retract as a single layer system.

Due to the unique combination of flexibility and strength of the design of the fabric fire shutter 400 of the present disclosure, the fabric fire shutter 400 can be utilized with several different deployment designs including traditional roller curtains with side guides, a multi-roller system and may include both vertical and horizontal accordion curtains, as well as brail, trip and straight lifts.

The fabric fire shutter 400 of the present disclosure has superior strength both as installed and after fire exposure, including superior cut tear and puncture resistance. It is capable of passing at least a 2 hour fire endurance test with flame penetration (ASTM E-119). Further, the fabric fire shutter 400 of the present disclosure is capable of withstanding a fire hose water exposure after the fire test.

### Example 1 Fire Hose Test

Scope & Purpose

Commissioned by U.S. Smoke & Fire Corporation, Reston, Va. Guardian conducted a technical evaluation fire test consistent with the procedures and acceptance criteria outlined in UL10B, (ref: NFPA 288) method for evaluating the ability of a door assembly, with pre-determined thermal exposure to retard the passage of fire through an opening. This test includes a defined exposure to a standard fire hose after the fire test. The test specimen is considered passing if there is no penetration of either flame during the fire test or water penetration by the hose stream. The fire conditions are consistent with the ASTM E-119 (UL263) fire curve and the hose steam methods in ASTM E-2226 for vertical surfaces.

b. General Information

As a leading NRTL for Fire Doors, Guardian Fire Testing Labs is qualified and accredited to conduct the UL10B Fire Test & Hose Stream. The TET was conducted on certified horizontal furnace. UL10B is used to test various door assemblies, materials and construction. The supporting structure must also be compliant.

The acceptance criteria Does Not include:

1. Risk by smoke generation, toxic outgassing or products of combustion.

2. Degree of control or passage limitation caused by smoke generation, heat transfer of flames on the unexposed sides

However, time temperature thermocouple reading will be recorded and reported for the unexposed side as well as observations as to surface flaming, smoking and surface conditions.

C. Test Objective:

The objective of this test was solely to determine if the design fabric fire shutter could exhibit sufficient strength and integrity to pass the standard hose stream test required as part of the UL10B test protocol, after the thermal endurance ASTM E-119 exposure.

3. Test Assembly

a. Construction Details

The test shutter was constructed from two layers of a wire reinforced, vermiculite impregnated, 800 gsm (base weight) fabric which has been coated on the exterior surfaces with an aluminum pigmented, high temperature stabilized polymer coating; this is a formulation of polyurethane, aluminum flake and pigments. The fabric was produced and fabricated exclusively for U.S. Smoke & Fire Corporation to their specifications.

The two fabric sheet layers are sewn together in a quilt pattern on 24″ centers, with stitch lines in both horizontal and vertical directions, using a double roll of stainless steel wire yarn. This construction allows the double layer fabric to roll as a single construction.

The shutter was designed to also test a ship-lap, off-set flat seam in the middle which may be required in some field installations to accommodate wide openings. The overlap may preferably be between six and twelve inches as opposed to smaller overlaps of 2 inches. In some embodiments of the present disclosure, the seams may be sealed using a high temperature caulk. 1¼ inch guide pin assemblies may preferably be installed on the edges to replicate the normal installation design.

b. Mounting for Test Purposes

The fabric fire shutter was installed on the test frame in a static deployed state, representative of an actual deployed fabric fire shutter. The installation included the use of side guides and the shutter was held in place by the guide pins.

The top was secured by a flat stock bar, instead of the traditional roller. This was done to accommodate the furnace test frame, and would have no impact on the test objective. The standard weighted bottom bar was installed at the bottom of the shutter.

The test frame was set in place so that the edge of the side guides, matched with the inside edge of the furnace frame so that the edge of the side guides and guide pins were fully exposed to the furnace temperatures.

Refractory ceramic fiber was packed around the furnace to seal the unit.

4. Conduct of Test

a. Fire Endurance Test and Observation

The fire endurance test was run for one hour, following the ASTM E-119 time/temperature curve. (See Table 1). (5) thermocouples were also attached to the unexposed side of the test shutter and monitored on (5) minute intervals.

Observation:

1. No surface flaming or flame penetration was observed for the entire test period.

2. Smoke was observed during the first 15 minutes of the test and then stopped for the duration of the test.

3. The unexposed side of the shutter did transition from silver, to black and back to a grey appearance during the fire test.

4. A slight glow from the SS Yarn was noted along one of the horizontal stitch lines.

5. Average of the unexposed side thermocouple readings were only 453° F., and no thermocouple was higher than 675 F

a. Hose Stream Test and Observation

Immediately following the fire endurance furnace test, the test fame was moved into position and subjected to the hose stream as prescribed by the UL10B test procedure.

Observations:

1) No water penetration was observed for duration

2) The hose stream did remove the caulk

3) The test shutter fabric was still fully intact on both the exposed and unexposed surfaces

4) The shutter fabric was still strong and flexible, to a point the tested shutter could be re-rolled when removed from the test frame.

5. Conclusion

b. Conditions of Acceptance

The test sample passed both the fire endurance and hose stream test as conducted in accordance with UL10B test procedure.

Based on this evaluation we believe that the tested configuration would in fact pass a full scale certified, UL10B test including the hose stream application.

TABLE 1

| T/C location | Ambient | Furnace Temp. ° F. | | | | | | Min | Max | |
|---|---|---|---|---|---|---|---|---|---|---|
| Time | 1 | 2 | 3 | 4 | 5 | Average | Target | 6 | 7 | 8 |
| :00 | 102 | 63 | 62 | 63 | 63 | | 68 | | | |
| :05 | 61 | 987 | 951 | 1035 | 1008 | 995 | 1000 | 900 | 1100 | |
| :10 | 62 | 1212 | 1168 | 1219 | 1225 | 1226 | 1300 | 1170 | 1430 | |
| :15 | 61 | 1373 | 1409 | 1268 | 1277 | 1339 | 1399 | 1259 | 1539 | |
| :20 | 66 | 1515 | 1500 | 1422 | 1326 | 1440 | 1462 | 1316 | 1608 | |
| :25 | 59 | 1514 | 1502 | 1425 | 1346 | 1446 | 1510 | 1359 | 1661 | |
| :30 | 57 | 1510 | 1522 | 1413 | 1339 | 1446 | 1550 | 1395 | 1705 | |
| :35 | 58 | 1510 | 1503 | 1431 | 1336 | 1445 | 1584 | 1426 | 1742 | |
| :40 | 60 | 1536 | 1555 | 1427 | 1363 | 1470 | 1613 | 1452 | 1774 | |
| :45 | 62 | 1545 | 1536 | 1449 | 1366 | 1474 | 1638 | 1474 | 1802 | |
| :50 | 64 | 1562 | 1532 | 1466 | 1360 | 1480 | 1661 | 1495 | | * |
| :55 | 66 | 1590 | 1584 | 1462 | 1376 | 1503 | 1681 | 1513 | | * |
| 1:00 | 66 | 1620 | 1615 | 1475 | 1362 | | 1700 | 1530 | 1870 | |

TABLE 2
UNEXPOSED SURFACE TEMP. ° F.

| Time | Upp. Lt. | Upp. Rt. | Center | Low. Lt. | Low. Rt. |
|---|---|---|---|---|---|
| :00 | 59 | 61 | 58 | 57 | 57 |
| :05 | 454 | 415 | 498 | 248 | 303 |
| :10 | 548 | 470 | 582 | 315 | 386 |
| :15 | 547 | 494 | 608 | 339 | 417 |
| :20 | 636 | 539 | 649 | 381 | 464 |
| :25 | 647 | 545 | 655 | 370 | 459 |
| :30 | 640 | 589 | 664 | 289 | 475 |
| :35 | 636 | 603 | 661 | 298 | 461 |
| :40 | 651 | 609 | 678 | 314 | 476 |
| :45 | 643 | 621 | 668 | 320 | 490 |
| :50 | 650 | 634 | 679 | 308 | 504 |
| :55 | 653 | 631 | 686 | 317 | 508 |
| 1:00 | 655 | 636 | 675 | 298 | 510 |

While preferred embodiments of this disclosure has been described above and shown in the accompanying drawings, it should be understood that applicant does not intend to be limited to the particular details described above and illustrated in the accompanying drawings, but intends to be limited only to the scope of the disclosure as defined by the following claims. In this regard, the term “configured” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1) A fire shutter, comprising:
A first fabric sheet and a second fabric sheet; wherein each fabric sheet is comprised of a reinforced texturized yarn and a polymer resin coating; wherein the reinforced texturized yarn is comprised of a fiberglass yarn and a steel wire;
wherein the reinforced texturized yarn comprises each fabric sheet;
wherein the first fabric sheet and the second fabric sheet are coated on one side with a high temperature stabilized, functionally filled polymer; and
wherein the first fabric sheet and the second fabric sheet are bonded wherein uncoated sides are adjacent, thereby forming the fire shutter.

2) The fire shutter of claim 1, wherein the first fabric sheet and the second fabric sheet are sewn together with a high temperature thread.

3) The fire shutter of claim 2, wherein the high temperature thread is at least one of a Kevlar thread and a stainless steel thread.

4) The fire shutter of claim 2, wherein the first fabric sheet and the second fabric sheet are sewn together in a quilt pattern, with stitch lines in horizontal and vertical directions, using a double roll of stainless steel wire.

5) The fire shutter of claim 1, wherein the fire shutter has an off-set ship-lap flat, butt seam.

6) The fire shutter of claim 1, wherein an interface exists between the first fabric sheet and the second fabric sheet.

7) The fire shutter of claim 1, wherein the high temperature stabilized, functionally filled polymer contains vermiculite.

8) The fire shutter of claim 1, wherein stitches are sewn in an accordion design in a vertical direction and a horizontal direction.

9) The fire shutter of claim 1, wherein the fiberglass yarn is a high temperature yarn comprised of at least one of e-glass grade silica fiber, S-glass grade silica fiber, quartz, aluminum borosilicate and ceramic material.

10) The fire shutter of claim 1, wherein the fire shutter utilizes a single roller system with enhanced side guide pins.

11) A fire shutter, comprising:
A first fabric sheet and a second fabric sheet; wherein each fabric sheet is comprised of a reinforced texturized yarn and a polymer resin coating; wherein the reinforced texturized yarn is comprised of a fiberglass yarn and a steel wire;
wherein the reinforced texturized yarn comprises each fabric sheet;
wherein the first fabric sheet and the second fabric sheet are coated on one side with a high temperature stabilized, functionally filled polymer;
wherein the first fabric sheet and the second fabric sheet are bonded wherein uncoated sides are adjacent, thereby forming the fire shutter;
wherein the first fabric sheet and the second fabric sheet are sewn together with a high temperature thread;
wherein the first fabric sheet and the second fabric sheet are sewn together in a quilt pattern, with stitch lines in both horizontal and vertical directions, using a double roll of stainless steel wire;
wherein an interface exists between the first fabric sheet and the second fabric sheet.

12) The fire shutter of claim 11, wherein the fire shutter has an off-set ship-lap flat, butt seam.

13) The fire shutter of claim 11, wherein an accordion design for sewing is utilized, both vertically and horizontally.

14) A method of assembling a fire shutter, comprising:
texturizing a fiberglass yarn;
combining the texturized yarn with a steel wire to form a reinforced texturized yarn;
weaving a plurality of strands of reinforced texturized yarn into a fabric sheet;
coating one side of the fabric sheet with a high temperature stabilized, functionally filled polymer;
intimately bonding a first fabric sheet and a second fabric sheet to form the fire shutter, wherein uncoated sides of the first fabric sheet and the second fabric sheet are on an interior portion of the fire shutter.

15) The method of claim 14, wherein bonding comprises sewing the first fabric sheet and the second fabric sheet with a high temperature thread.

16) The method of claim 14, wherein a plurality of heavy duty guide tabs are closely and evenly spaced and a plurality of pins are closely and evenly spaced.

17) The method of claim 14, wherein a plurality of enhanced guide pins are used to anchor the fire shutter to a plurality of side guides.

18) The method of claim 14, further comprising texturizing the fiberglass yarn using a lex process and a volumization process.

19) The method of claim 14, further comprising providing an off-set ship-lap flat, butt seam.

20) The method of claim 14, wherein the fire shutter is capable of passing at least a 2 hour fire endurance test with flame penetration (ASTM E-119) and withstanding a fire hose water exposure after the fire endurance test.
